(19) United States
(12) Patent Application Publication
(10) Pub. No.: US 2024/0344353 A1
(43) Pub. Date: Oct. 17, 2024

(54) FOAM-INJECTED SLAT AND METHOD OF MANUFACTURING THEREOF

(71) Applicant: Mohammad Mumtaz Daaboul, St. Mississauga (CA)

(72) Inventor: Mohammad Mumtaz Daaboul, St. Mississauga (CA)

(21) Appl. No.: 18/301,233

(22) Filed: Apr. 16, 2023

(51) Int. Cl. E04H 17/16; B29C 44/12; B29C 44/14; B29C 44/18; B29C 44/34; E04H 17/14

(52) U.S. Cl. CPC E04H 17/165; B29C 44/128; B29C 44/146; B29C 44/18; B29C 44/3415; E04H 17/143; E04H 17/1478; E04H 17/1602; B29K 2075/00; B29K 2305/02; B29L 2031/73

(57) ABSTRACT

The present invention is directed to a foam-injected slat and a method of manufacturing thereof used in building fencing, privacy screens, pergolas, louvers, wall claddings, and other similar types of structures. Use of foam-injected slats in the aforementioned structures provides noise reduction, heat insulation, and vibration absorption. In addition, they are lightweight, strong, durable in heavy weather conditions, environmentally friendly, easy to install, and cost effective. Lastly, the manufacturing process enables the forming of a special locking mechanism that further strengthens the foam-injected slats.

### FIELD OF THE INVENTION

The present invention is directed to a foam-injected slat and method of manufacturing thereof used in building fencing, privacy screens, pergolas, louvers, wall claddings, and other similar types of structures. More specifically, use of foam-injected slats in the aforementioned structures provides noise reduction, heat insulation, and vibration absorption. In addition, they are strong, lightweight, durable in heavy weather conditions, environmentally friendly, easy to install, and cost effective.

### BACKGROUND OF THE INVENTION

There are many ways to build fencing, privacy screens, pergolas, louvers, or wall claddings. Wood, vinyl, and aluminum are common materials used in the paneling, posts, and/or rails of these types of structures.

Wood is generally less expensive than vinyl or aluminum, but is not sustainable in comparison. Wood has a shorter lifespan when used for outdoor applications. Its longevity may be extended by staining the wood or painting; however, periodic maintenance of reapplying these products is necessary. In addition, wood is heavier in weight and not always uniform in its appearance.

Vinyl is more expensive than wood and lighter in weight. Vinyl can also provide a user with a more uniform appearance for their final product. However, vinyl is not as sturdy in heavy weather events like thunderstorms and high wind speeds.

Aluminum is another material option for fencing if privacy is not a concern. Generally, aluminum fencing is vertical aluminum posts with large gaps in between each post. Although aluminum is strong and durable in many heavy weather events, it is not light weight and can be quite costly.

Therefore, there exists a need for a foam-injected slat that is strong, lightweight, weather durable, and cost effective that can be used to build fencing privacy screens, pergolas, louvers, and wall claddings.

### SUMMARY OF THE INVENTION

The present invention is directed to a foam-injected slat and method of manufacturing thereof.

In an exemplary embodiment, a foam-injected slat comprises (a) an aluminum profile, wherein the aluminum profile comprises of an aluminum sheet, wherein the aluminum sheet comprises an interior surface, an exterior surface, a first end, and a second end, wherein the aluminum profile is formed from the aluminum sheet by roll forming; (b) a locking mechanism; and (c) foam, wherein the foam is injected into the formed aluminum profile expanding to the interior surface of the aluminum profile.

In one embodiment, the exterior surface of the aluminum sheet further comprises a coating of polyurethane polyamide, acrylic, silicone polyester, polyvinyl chloride, plastisol, fluorocarbons, polyurethane, polyvinylidene fluoride, polyester, paint, or any combination thereof. In an embodiment, the interior surface of the aluminum sheet further comprises of an epoxy back coating.

In an exemplary embodiment, the foam comprises of a polyurethane mixture. In an alternate embodiment, the foam comprises of a polyisocyanurate mixture. In one embodiment, the foam-injected slat is about 20 mm in height, between about 40 mm to about 100 mm in width, and between about 1 m to about 6 m in length.

In yet another embodiment, a method of manufacturing the foam-injected slat comprises the following steps: (1) unwinding a master aluminum coil; (2) coating the exterior surface using a continuous coil coating process; (3) coating the interior surface with an epoxy back coating; (4) slitting aluminum coil into desired width making a plurality of the aluminum sheet; (5) inserting the slitted aluminum sheet into a roll forming machine to form the aluminum profile and repeating until desired shape is attained; (6) heating the aluminum profile to about 40° C.; (7) heating isocyanate and polyol to 20° C.; (8) mixing 100 g isocyanate to 160 g polyol creating a polyurethane mixture; (9) pumping the polyurethane mixture into foam mixing head and mix at 2875 rpm; (10) injecting the polyurethane mixture into the aluminum profile at a flow rate based on volume; (11) bending the first end and the second end together creating the locking mechanism; (12) waiting about 33 to 41 seconds allowing the polyurethane mixture to harden; (13) cutting the foam-injected aluminum profiles into desired length creating the foam-injected slat.

In one embodiment, the coating for the exterior surface comprises of polyurethane polyamide, acrylic, silicone polyester, polyvinyl chloride, plastisol, fluorocarbons, polyurethane, polyvinylidene fluoride, polyester, paint, or any combination thereof. In another embodiment, the desired width of the aluminum sheet is between about 100 mm and about 270 mm in width and is between about 0.30 and about 0.70 in thickness.

In one embodiment, the desired shape of the aluminum profile is a hollow rectangle. In another embodiment, the desired shape of the aluminum profile is a hollow square. In an embodiment, the desired length of the foam-injected aluminum profile is between about 1 m and about 6 m.

In an exemplary embodiment, a vertical fence system comprises (a) at least two rail, a first rail and second rail, wherein the first rail and second rail comprises of three sides in the shape of a U with a hollow middle; (b) a plurality of the foam-injected slat; wherein the foam-injected slat comprises (i) a slat first end, (ii) a slat second end, and (iii) a long side, wherein plurality of the foam-injected slat are perpendicular to the first rail and the second rail, evenly spaced vertically, and fixedly attached between the first rail and the second rail; (iv) the slat first end is removably attached to the first rail by inserting the first end into middle section of the first rail; and (v) the slat second end is removably attached to the second rail by inserting the second end into middle section of the second rail; (c) at least two post, a first post and a second post, located on the lateral outer end of the vertical fence system, wherein the first post and the second post comprises (i) a stake, wherein the stake comprises of four sides in a rectangular shape; a stake top end; a stake bottom end; a plurality of indentions on the stake top end; and a groove, wherein the groove extends vertically down three of the four sides; (ii) a post cover, wherein the post cover comprises of three sides in the shape of a U and secures over the longer side of the stake; (iii) a post cap, wherein the post cap comprises of a plurality of protrusions and is fixedly attached to the stake by inserting the plurality of protrusions into the plurality of indentions on the stake top end; (iv) a base plate, wherein the base plate is rectangular in shape; (v) a plurality of cover fasteners; (vi) a base cover, wherein the base cover is rectangular in shape with a hollow middle section and secures to the stake bottom end of the stake using the plurality of cover fasteners; and (vii) a plurality of plate fasteners, wherein the plurality of plate fasteners secure the base plate to the base cover; and (d) a plurality of spacer; wherein the plurality of spacer are removably attached in the first rail between each of the first end of the foam-injected slat and the plurality of spacer are removably attached in the second rail between each of the second end of the foam-injected slat.

In one embodiment, the rail, the stake, and the post cover are constructed using the extrusion process. In another embodiment, the material of construction for the rail, the stake, the post cover, the post cap, the base plate, and the base cover comprises of aluminum, aluminum alloy, metal, vinyl, plastic, or any combination thereof.

In an alternate embodiment, the cover fasteners comprise of roll-black screws, thread rolling screws, screws, bolts, or any combination thereof. In yet another embodiment, the plate fasteners comprise of fixing post screws, binding post screws, bolts, screws, or any combination thereof.

In an exemplary embodiment, a horizontal fence system comprises of (a) at least two post, a first post and a second post, located on the lateral outer end of the vertical fence system, wherein the first post and the second post comprises (i) a stake, wherein the stake comprises of four sides in a rectangular shape; a stake top end; a stake bottom end; a plurality of indentions on the stake top end; and a groove, wherein the groove extends vertically down three of the four sides; (ii) a post cover, wherein the post cover comprises of three sides in the shape of a U and secures over longer side of the stake; (iii) a post cap, wherein the post cap comprises of a plurality of protrusions and is fixedly attached to the stake by inserting the plurality of protrusions into the plurality of indentions on the stake top end; (iv) a base plate, wherein the base plate is rectangular in shape; (v) a plurality of cover fasteners; (vi) a base cover, wherein the base cover is rectangular in shape with a hollow middle section and secures to the stake bottom end of the stake using the plurality of cover fasteners; and (vii) a plurality of plate fasteners, wherein the plurality of plate fasteners secure the base plate to the base cover; (b) a plurality of the foam-injected slat; wherein the foam-injected slat comprises (i) a slat first end, (ii) a slat second end, (iii) a long side, wherein a plurality of the foam-injected slat are perpendicular to the first post and the second post, evenly spaced horizontally, and fixedly attached between the first post and the second post; and (iv) the slat first end is removably attached to the first post by inserting the slat first end into the groove of the stake; and (v) the slat second end is removably attached to the second post by inserting the slat second end into the groove of the stake; (c) a plurality of spacer; wherein the plurality of spacer are removably attached in the first post between each of the first end of the foam-injected slat and the plurality of spacer are removably attached in the second post between each of the second end of the foam-injected slat.

In an embodiment, the stake and the post cover are constructed using the extrusion process. In another embodiment, the material of construction for the stake, the post cover, the post cap, the base plate, and the base cover comprises of aluminum, aluminum alloy, metal, vinyl, plastic, or any combination thereof.

In one embodiment, the cover fasteners comprise of roll-black screws, thread rolling screws, screws, bolts, or any combination thereof. In yet another embodiment, the plate fasteners comprise of fixing post screws, binding post screws, bolts, screws, or any combination thereof.

Various objects, features, aspects, and advantages of the inventive subject matter will become apparent from the following detailed description of exemplary embodiments, along with the accompanying figures in which like numerals represent like components.

### BRIEF DESCRIPTION OF DRAWINGS

FIG. 1 depicts the front view of an exemplary embodiment of a plurality of foam-injected slat.

FIG. 2 depicts the perspective view of an exemplary embodiment of a foam-injected slat.

FIG. 3A depicts the front view of an exemplary embodiment of a foam-injected slat.

FIG. 3B depicts the front view of an exemplary embodiment of a foam-injected slat.

FIG. 4 depicts the side view of an exemplary embodiment of a foam-injected slat.

FIG. 5 depicts the perspective view of an exemplary embodiment of a vertical fence system.

FIG. 6 depicts the exploded view of an exemplary embodiment of a vertical fence system.

FIG. 7 depicts the perspective view of an exemplary embodiment of a horizontal fence system.

FIG. 8 depicts the exploded view of an exemplary embodiment of a horizontal fence system.

### DETAILED DESCRIPTION OF THE INVENTION

The following description is not an admission that any of the information provided herein is prior art or relevant to the present invention, or that any publication specifically or implicitly referenced is prior art. Any publications cited in the description are incorporated by reference herein. Where a definition or use of a term in an incorporated reference is inconsistent or contrary to the definition of that term provided herein, the definition of that term provided herein applies and the definition of that term in the reference does not apply.

As used in the description herein and throughout the claims that follow, the meaning of “a,” “an,” and “the” includes plural reference unless the context clearly dictates otherwise. Also, as used in the description herein, the meaning of “in” includes “into” and “on” unless the context clearly dictates otherwise.

As used herein, the term “about” in conjunction with a numeral refers to a range of that numeral starting from 10% below the absolute value of the numeral to 10% above the absolute value of the numeral, inclusive.

As used herein, the terms “formed” and “profiled” are used interchangeably throughout the disclosure.

As used herein, the terms “slat” and “paneling” are used interchangeably throughout the disclosure.

The present invention is directed to a foam-injected slat and a method of manufacturing thereof used in building fencing, privacy screens, pergolas, louvers, wall claddings, and other similar types of structures. Use of foam-injected slats in the aforementioned structures provides noise reduction, heat insulation, and vibration absorption. In addition, they are strong, lightweight, durable in heavy weather conditions, environmentally friendly, easy to install, and cost effective. Lastly, the manufacturing process enables the forming of a special locking mechanism that further strengthens the foam-injected slats.

The method of manufacturing allows for variation in the density of the foam which is based on the user's preference. Foam density can range between about 50 kg/m³ to about 120 kg/m³. The preferred foam density of a foam-injected slat is between about 60 kg/m³ to about 75 kg/m³. Another feature of the manufacturing process is the user's ability to choose the size, design, and/or color preference for their foam-injected slats which allows for use in various applications.

The aluminum sheet allows for bending between 90 and 180 degrees without cracking according to EN-485-2 testing standard.

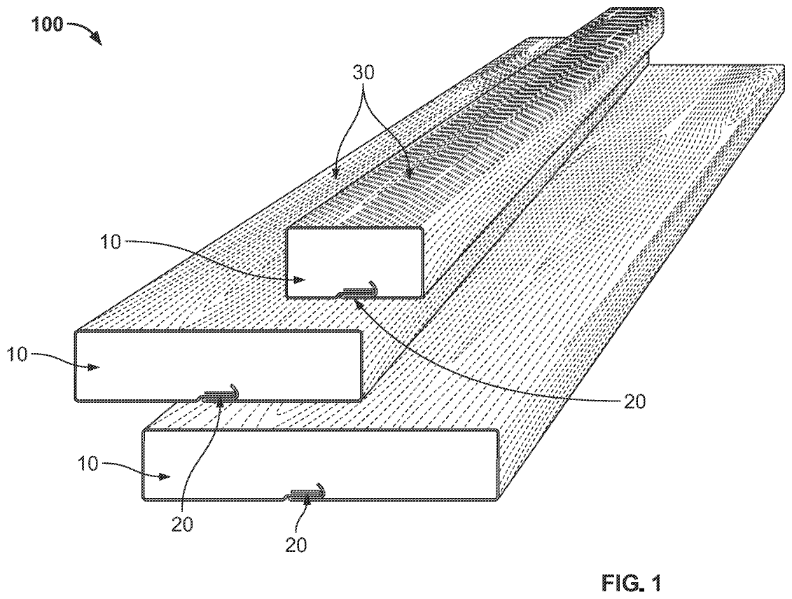

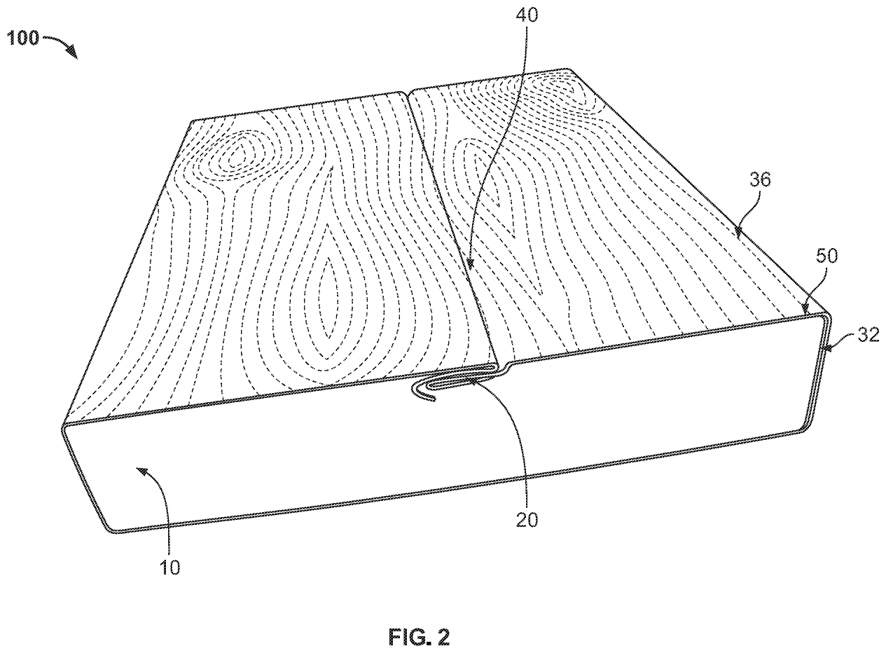

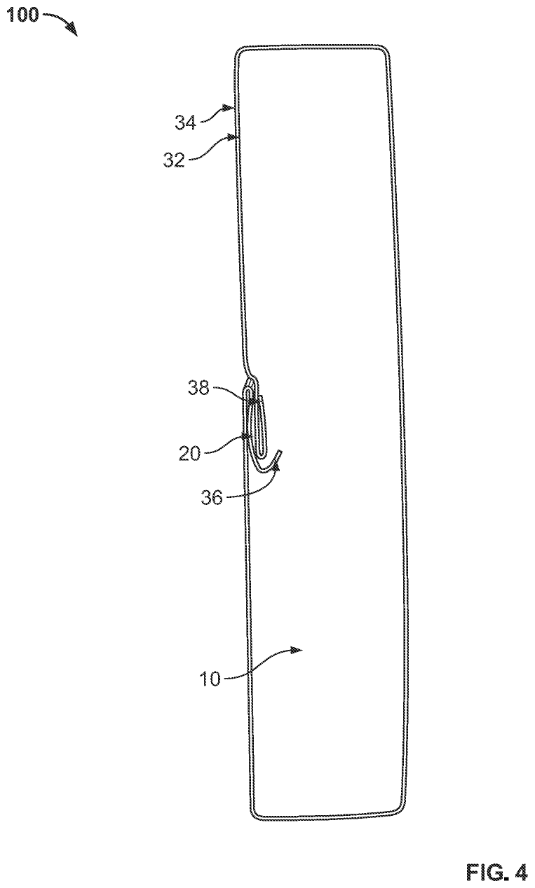

Exemplary configurations of the present invention are depicted in FIGS. 1-8, in which a plurality of foam-injected slat 100 are configured to be used in building fencing, privacy screens, pergolas, louvers, wall claddings, or other similar type structures. In one embodiment, foam-injected slat 100 comprises aluminum profile 50; a locking mechanism 20; and foam 10. In this embodiment, aluminum profile 50 is formed from aluminum sheet 30; wherein aluminum sheet 30 comprises interior surface 32, exterior surface 34, first end 36, and second end 38. In one embodiment, first end 36 of aluminum sheet 30 bends inward toward interior surface 32 and second end 38 folds over bent first end 36 creating locking mechanism 20 (see FIG. 4). Foam 10 comprises of a polyurethane mixture that expands and hardens against interior surface 32 after being poured into formed aluminum profile 50.

In an alternate embodiment, foam 10 comprises of a polyisocyanurate mixture that expands and hardens against interior surface 32 after being poured into formed aluminum profile 50.

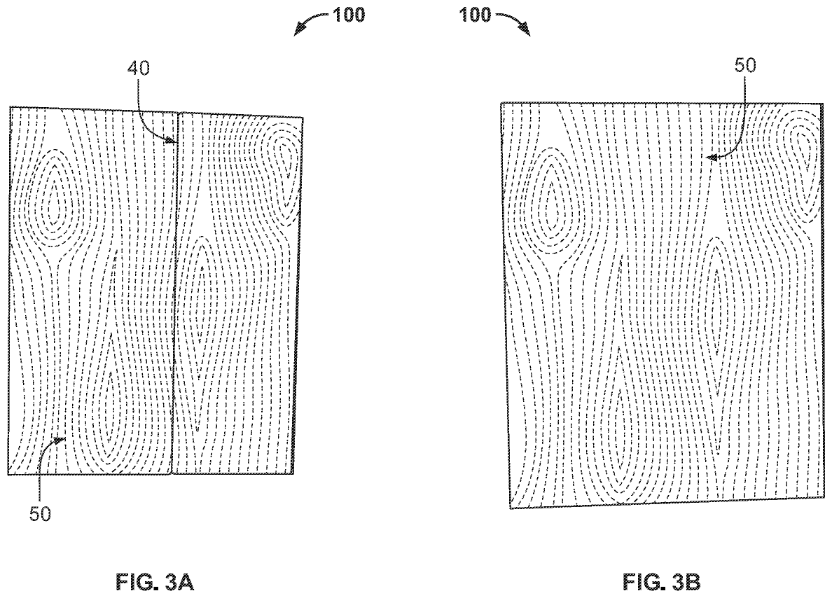

In an embodiment, locking mechanism 20 provides added support through the middle length of foam-injected slat 100 by creating fold 40 (see FIG. 3A). In an alternate embodiment, fold 40 can be used as a secure place to hang adornments.

In one embodiment, the method of manufacturing foam-injected slat 100 comprises the following steps. Step one comprises of unwinding a master aluminum coil. Step two comprises of coating exterior surface 34 using a continuous coil coating process based on user's preference of design and color. In one embodiment, the coil coating comprises of polyurethane polyamide. In an alternate embodiment, the coil coating comprises of acrylic, silicone polyester, polyvinyl chloride, plastisol, fluorocarbons, polyurethane, polyvinylidene fluoride, polyester, paint, or any combination thereof. One of ordinary skill in the art can envision other coatings for exterior surface 34 that are within the scope of the present invention.

Step three comprises of coating interior surface 32 with an epoxy back coating for foam adhesion. Step four comprises of slitting aluminum coil into desired width making a plurality of aluminum sheet 30. In this embodiment, aluminum sheet 30 comprises interior surface 32, exterior surface 34, first end 36, and second end 38. In one embodiment, slitted aluminum sheet 30 is about 270 mm in width and between about 0.30 mm and about 0.70 mm in thickness. In another embodiment, slitted aluminum sheet 30 is between about 100 mm and about 270 mm in width. Length of aluminum sheet 30 is dependent on the length of the master aluminum coil. In one embodiment, master aluminum coil is between about 2000 m and about 4000 m.

Step five comprises of inserting slitted aluminum sheet 30 into a roll forming machine forming an aluminum profile 50. Step five is repeated until the desired shape is formed. During this step, first end 36 and second end 38 are not locked together. Step six comprises of heating aluminum profile 50 to about 40° C. Increasing the temperature of aluminum profile 50 helps with the reaction process after injection of foam mixture.

Step seven comprises of heating isocyanate and polyol to 20° C. Step eight comprises of mixing 100 g isocyanate with 160 g polyol creating a polyurethane mixture. The ratio of 5 parts isocyanate to 8 parts polyol is important and should be maintained when changing the measurements of either compound. Step nine comprises of pumping polyurethane mixture into foam mixing head and mixing at 2875 rpm. Step ten comprises of injecting polyurethane mixture into formed aluminum profile 50 at a flow rate based on the volume until desired foam density is reached while not exceeding the maximum line speed of 1.2 kg/min. In a preferred embodiment, foam density is between about 60 kg/m³ and about 75 kg/m³. In an alternate embodiment, foam density is between about 50 kg/m³ and 120 kg/m³. Changing the foam density alters the weight and strength of foam-injected slat 100 and is based on user's preference.

Step eleven comprises of bending first end 36 and second end 38 into a quad fold locking both first end 36 and second end 38 together creating locking mechanism 20 (see FIG. 4). In this embodiment, the reaction time is between about 8 and about 12 seconds, the gel time is between about 21 and about 25 seconds, and the hardening time is between about 33 and about 41 seconds. Step twelve comprises of waiting between about 33 to about 41 seconds for foam 10 to fully harden. Step thirteen comprises of cutting foam-injected aluminum profile 50 into sections creating foam-injected slat 100 used in building fencing, privacy screens, pergolas, louvers, wall claddings, and other similar types of structures.

In one embodiment, the desired length of foam-injected slat 100 is about 6 m. In an alternate embodiment, the desired length is between about 1 m and about 12 m. One of ordinary skill in the art can envision other lengths for foam-injected slat 100 that are within the scope of the present invention.

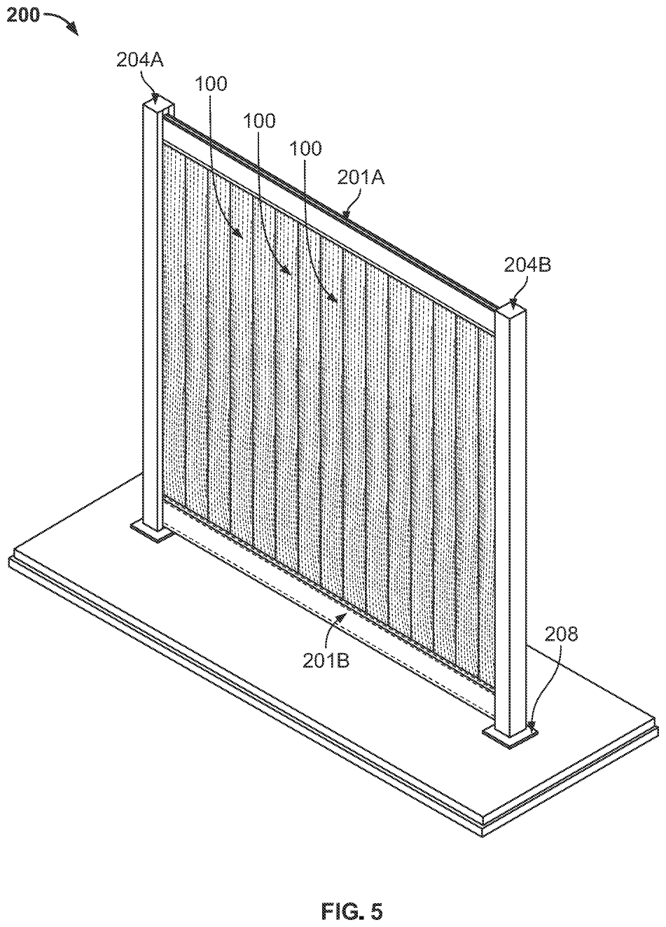

FIG. 5 depicts the perspective view of an exemplary embodiment of vertical fence system 200. In an exemplary embodiment, vertical fence system 200 comprises of at least two rail 201; at least two post 204, wherein post 204 comprises of post cap 202, stake 216, post cover 205, base plate 207, base cover 208, a plurality of cover fasteners 206, and a plurality of plate fasteners 209; a plurality of foam-injected slat 100, wherein foam-injected slat 100 comprises of slat first end 60, slat second end 62, and long side 64; and a plurality of spacer 203. Stake 216 comprises of stake top end 211, wherein stake top end 211 comprises of a plurality of indentions 215; stake bottom end 212; and a groove 210.

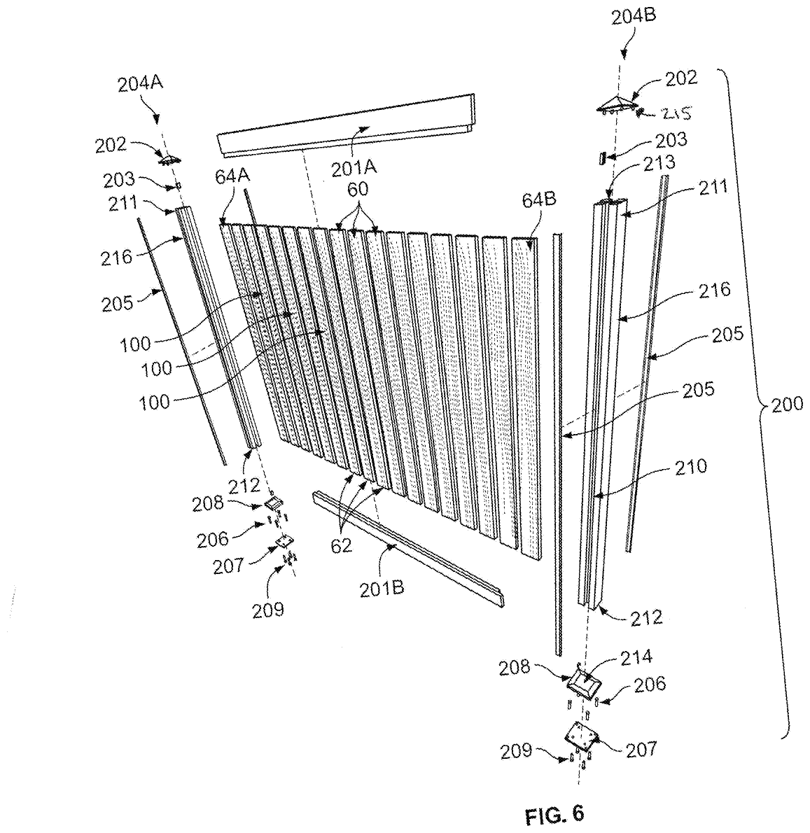

In this embodiment, rail 201, stake 216, and post cover 205 are constructed using an extrusion process. Rail 201 comprises of three sides in the shape of a U with a hollow middle capable of receiving slat first end 60 or slat second end 62 and plurality of spacer 203. Stake 216 comprises of four sides in a rectangular shape having groove 210 extending vertically down three sides, wherein groove 210 is capable of receiving long side 64 of foam-injected slat 100. Post cover 205 comprises of three sides in the shape of a U capable of being secured over longer side of post 204 effectively covering any unused groove 210 on stake 216 (see FIG. 6).

In this embodiment, plurality of foam-injected slat 100 are perpendicular to rail 201, evenly spaced vertically, and fixedly attached between at least two rail 201, first rail 201A and second rail 201B; wherein slat first end 60 of each of the plurality of foam-injected slat 100 are inserted into hollow middle of first rail 201A and slat second end 62 of each of the plurality of foam-injected slat 100 are inserted into hollow middle of second rail 201B. A plurality of spacer 203 provides a buffer between each foam-injected slat 100 and are inserted between each slat first end 60 within first rail 201A and between each slat second end 62 within second rail 201B to ensure equal distance is maintained between them. Each post 204 is parallel to plurality of foam-injected slat 100 and fixedly attached to long side 64 of a foam-injected slat 100 on lateral outer ends of vertical fence system 200. In one embodiment, vertical fence system 200 comprises at least two post 204, first post 204A and second post 204B; wherein first long side 64A of foam-injected slat 100 tightly inserts into groove 210 on first post 204A and second long side 64B of foam-injected slat 100 tightly inserts into groove 210 on second post 204B (see FIG. 6).

In an embodiment, stake top end 211 comprises of a plurality of indentions 213 and post cap 202 comprises of a plurality of protrusions 215; wherein plurality of protrusions 215 on post cap 202 secure into plurality of indentions 213 on stake top end 211 providing post 204 with protection from outdoor elements. Base cover 208 is rectangular in shape with hollow middle section 214, wherein hollow middle section 214 fits over stake bottom end 212 and is secured in place by a plurality of cover fasteners 206. Base plate 207 secures to base cover 208 by a plurality of plate fasteners 209.

In one embodiment, material of construction for vertical fence system 200 comprises aluminum, aluminum alloy, metal, vinyl, plastic, or any combination thereof. In an embodiment, cover fasteners 206 comprise of roll-black screws, thread rolling screws, screws, bolts, or any combination thereof. In another embodiment, plate fasteners 209 comprise of fixing post screws, binding post screws, bolts, screws, or any combination thereof. One of ordinary skill in the art can envision other types of material of construction for vertical fence system 200, cover fasteners 206, and plate fasteners 209 that are within the scope of the present invention.

In an alternate embodiment, vertical fence system 200 can be expanded by adding additional sections of rail 201, post 204, plurality of foam-injected slat 100, and plurality of spacer 203. For example, in one embodiment, a section of vertical fence system 200 comprises of two rail 201, two post 204, fifteen foam-injected slat 100, and thirty spacer 203. In another embodiment, a section of vertical fence system 200 comprises of fifty rail 201, fifty post 204, two hundred foam-injected slat 100, and four hundred spacer 203.

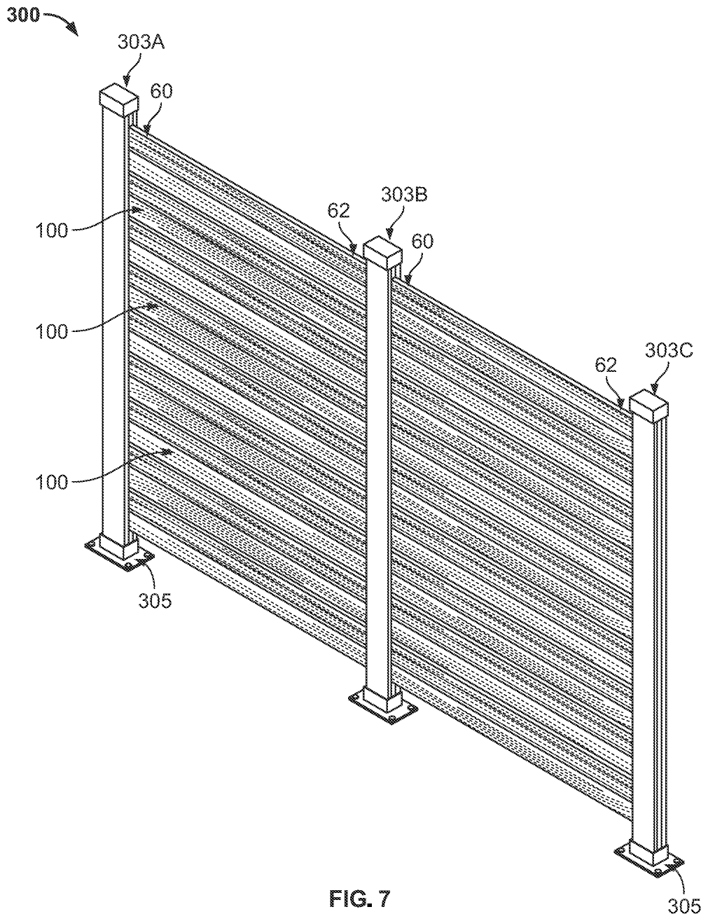

FIG. 7 depicts the perspective view of an exemplary embodiment of a horizontal fence system 300. In an exemplary embodiment, horizontal fence system 300 comprises of at least two post 303, wherein post 303 comprises of stake 316, post cap 301, post cover 304, base cover 305, base plate 306, a plurality of cover fasteners, and a plurality of plate fasteners; a plurality of spacer 302; and a plurality of foam-injected slat 100, wherein foam-injected slat 100 comprises of slat first end 60, slat second end 62, and long side 64. Stake 316 comprises of stake top end 311, wherein stake top end 311 comprises of a plurality of indentions 315; stake bottom end 312; and a groove 310.

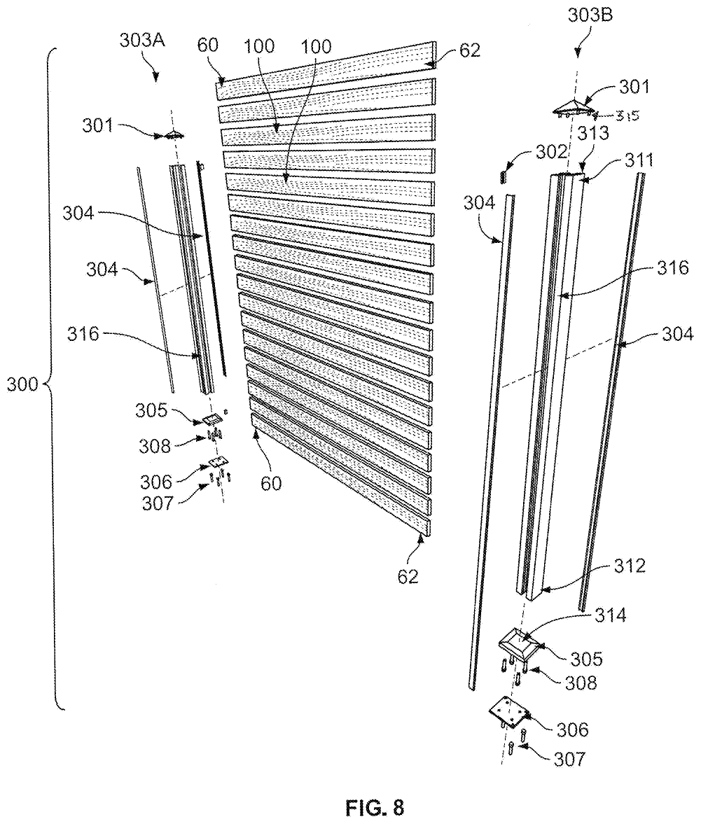

In this embodiment, stake 316 and post cover 304 are constructed using an extrusion process. Stake 316 comprises of four sides in a rectangular shape having groove 310 extending vertically down three sides, wherein groove 310 is capable of receiving slat first end 60 and slat second end 62 of foam-injected slat 100 and a plurality of spacer 302. Post cover 304 comprises of three sides in the shape of a U capable of being secured over longer side of stake 316 effectively covering any unused groove 310 on stake 316 (see FIG. 8).

In this embodiment, plurality of foam-injected slat 100 are perpendicular to post 303, evenly spaced horizontally, and fixedly attached between at least two post 303, first post 303A and second post 303B; wherein slat first end 60 of each of the plurality of foam-injected slat 100 are inserted into groove 310 of first post 303A and slat second end 62 of each of the plurality of foam-injected slat 100 are inserted into groove 310 of second post 303B (see FIG. 8). A plurality of spacer 302 provides a buffer between each foam-injected slat 100 and are inserted between each slat first end 60 within first post 303A and between slat second end 62 within second post 303B to ensure equal distance is maintained between them.

In an embodiment, post top end 311 comprises of a plurality of indentions 313 and post cap 301 comprises of a plurality of protrusions 315; wherein plurality of protrusions 315 on post cap 301 secure into plurality of indentions 313 on post top end 311 providing post 303 with protection from outdoor elements. Base cover 305 is rectangular in shape with hollow middle section 314, wherein hollow middle section 314 fits over post bottom end 312 and is secured in place by a plurality of cover fasteners 308. Base plate 306 secures to base cover 305 by a plurality of plate fasteners 307.

In one embodiment, material of construction for horizontal fence system 300 comprises aluminum, aluminum alloy, metal, vinyl, plastic, or any combination thereof. In an embodiment, cover fasteners 308 comprise of roll-black screws, thread rolling screws, screws, bolts, or any combination thereof. In another embodiment, plate fasteners 307 comprise of fixing post screws, binding post screws, bolts, screws, or any combination thereof. One of ordinary skill in the art can envision other types of material of construction for horizontal fence system 300, cover fasteners 308, and plate fasteners 307 that are within the scope of the present invention.

In an alternate embodiment, horizontal fence system 300 can be expanded by adding additional sections of post 303, plurality of foam-injected slat 100, and plurality of spacer 302. For example, in one embodiment, a section of horizontal fence system 300 comprises of two post 303, fifteen foam-injected slat 100, and thirty spacer 302. In another embodiment, a section of horizontal fence system 300 comprises of fifty post 303, two hundred foam-injected slat 100, and four hundred spacer 302.

Thus, various embodiments of foam-injected slat and the method of manufacturing thereof have been disclosed. It should be apparent, however, to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

1. A foam-injected slat, comprising:
a. an aluminum profile, wherein said aluminum profile comprises of an aluminum sheet, wherein said aluminum sheet comprises an interior surface, an exterior surface, a first end, and a second end, wherein said aluminum profile is formed from said aluminum sheet by roll forming;
b. a locking mechanism; and
c. foam, wherein said foam is injected into said formed aluminum profile expanding to said interior surface of said aluminum profile.

2. The foam-injected slat as recited in claim 1, wherein said exterior surface of said aluminum sheet further comprises a coating of polyurethane polyamide, acrylic, silicone polyester, polyvinyl chloride, plastisol, fluorocarbons, polyurethane, polyvinylidene fluoride, polyester, paint, or any combination thereof.

3. The foam-injected slat as recited in claim 1, wherein said interior surface of said aluminum sheet further comprises of an epoxy back coating.

4. The foam-injected slat as recited in claim 1, wherein said foam comprises of a polyurethane mixture.

5. The foam-injected slat as recited in claim 1, wherein said foam comprises of a polyisocyanurate mixture.

6. The foam-injected slat as recited in claim 1, wherein said foam-injected slat is about 20 mm in height, between about 40 mm to about 100 mm in width, and between about 1 m to about 6 m in length.

7. A method of manufacturing said foam-injected slat according to claim 1, comprising:
a. unwinding a master aluminum coil;
b. coating said exterior surface using a continuous coil coating process;
c. coating said interior surface with an epoxy back coating;
d. slitting aluminum coil into desired width making a plurality of said aluminum sheet;
e. inserting said slitted aluminum sheet into roll forming machine to form said aluminum profile and repeating until desired shape is attained;
f. heating said aluminum profile to about 40° C.;
g. heating isocyanate and polyol to 20° C.;
h. mixing 100 g isocyanate to 160 g polyol creating a polyurethane mixture;
i. pumping said polyurethane mixture into foam mixing head and mix at 2875 rpm;
j. injecting said polyurethane mixture into said aluminum profile at a flow rate based on volume;
k. bending said first end and said second end together creating said locking mechanism;
l. waiting about 33 to 41 seconds allowing said polyurethane mixture to harden;
m. cutting said foam-injected aluminum profiles into desired length creating said foam-injected slat.

8. The method of manufacturing said foam-injected slat according to claim 7, wherein said coating for said exterior surface comprises of polyurethane polyamide, acrylic, silicone polyester, polyvinyl chloride, plastisol, fluorocarbons, polyurethane, polyvinylidene fluoride, polyester, paint, or any combination thereof.

9. The method of manufacturing said foam-injected slat according to claim 7, wherein said desired width of said aluminum sheet is between about 100 mm and about 270 mm in width.

10. The method of manufacturing said foam-injected slat according to claim 7, wherein said aluminum sheet is between about 0.30 and about 0.70 in thickness.

11. The method of manufacturing said foam-injected slat according to claim 7, wherein said desired shape of said aluminum profile is a hollow rectangle.

12. The method of manufacturing said foam-injected slat according to claim 7, wherein said desired shape of said aluminum profile is a hollow square.

13. The method of manufacturing said foam-injected slat according to claim 7, wherein said desired length of said foam-injected aluminum profile is between about 1 m and about 6 m.

14. A vertical fence system comprising:
a. at least two rail, a first rail and second rail, wherein said first rail and second rail comprises of three sides in the shape of a U with a hollow middle;
b. a plurality of said foam-injected slat; wherein said foam-injected slat comprises:
i. a slat first end,
ii. a slat second end, and
iii. a long side, wherein plurality of said foam-injected slat are perpendicular to said first rail and said second rail, evenly spaced vertically, and fixedly attached between said first rail and said second rail;
iv. said slat first end is removably attached to said first rail by inserting said first end into middle section of said first rail; and
v. said slat second end is removably attached to said second rail by inserting said second end into middle section of said second rail;
c. at least two post, a first post and a second post, located on the lateral outer end of said vertical fence system, wherein said first post and said second post comprises:
i. a stake, wherein said stake comprises of four sides in a rectangular shape; a stake top end; a stake bottom end; a plurality of indentions on said stake top end; and a groove, wherein said groove extends vertically down three of said four sides;
ii. a post cover, wherein said post cover comprises of three sides in the shape of a U and secures over longer side of said stake;
iii. a post cap, wherein said post cap comprises of a plurality of protrusions and is fixedly attached to said stake by inserting said plurality of protrusions into said plurality of indentions on said stake top end;
iv. a base plate, wherein said base plate is rectangular in shape;
v. a plurality of cover fasteners;
vi. a base cover, wherein said base cover is rectangular in shape with a hollow middle section and secures to said stake bottom end of said stake using said plurality of cover fasteners; and
vii. a plurality of plate fasteners, wherein said plurality of plate fasteners secure said base plate to said base cover; and
d. a plurality of spacer; wherein said plurality of spacer are removably attached in said first rail between each of said first end of said foam-injected slat and said plurality of spacer are removably attached in said second rail between each of said second end of said foam-injected slat.

15. The vertical fence system according to claim 14, wherein said rail, said stake, and said post cover are constructed using the extrusion process.

16. The vertical fence system according to claim 14, wherein the material of construction for said rail, said stake, said post cover, said post cap, said base plate, and said base cover comprises of aluminum, aluminum alloy, metal, vinyl, plastic, or any combination thereof.

17. The vertical fence system according to claim 14, wherein said cover fasteners comprise of roll-black screws, thread rolling screws, screws, bolts, or any combination thereof.

18. The vertical fence system according to claim 14, wherein said plate fasteners comprises of fixing post screws, binding post screws, bolts, screws, or any combination thereof.

19. A horizontal fence system comprising:
a. at least two post, a first post and a second post, located on the lateral outer end of said vertical fence system, wherein said first post and said second post comprises:
i. a stake, wherein said stake comprises of four sides in a rectangular shape; a stake top end; a stake bottom end; a plurality of indentions on said stake top end; and a groove, wherein said groove extends vertically down three of said four sides;
ii. a post cover, wherein said post cover comprises of three sides in the shape of a U and secures over longer side of said stake;
iii. a post cap, wherein said post cap comprises of a plurality of protrusions and is fixedly attached to said stake by inserting said plurality of protrusions into said plurality of indentions on said stake top end;
iv. a base plate, wherein said base plate is rectangular in shape;
v. a plurality of cover fasteners;
vi. a base cover, wherein said base cover is rectangular in shape with a hollow middle section and secures to said stake bottom end of said stake using said plurality of cover fasteners; and
vii. a plurality of plate fasteners, wherein said plurality of plate fasteners secure said base plate to said base cover;
b. a plurality of said foam-injected slat; wherein said foam-injected slat comprises:
i. a slat first end,
ii. a slat second end, and
iii. a long side, wherein plurality of said foam-injected slat are perpendicular to said first post and said second post, evenly spaced horizontally, and fixedly attached between said first post and said second post; and
iv. said slat first end is removably attached to said first post by inserting said slat first end into said groove of said stake;
v. said slat second end is removably attached to said second post by inserting said slat second end into said groove of said stake; and
c. a plurality of spacer; wherein said plurality of spacer are removably attached in said first post between each of said first end of said foam-injected slat and said plurality of spacer are removably attached in said second post between each of said second end of said foam-injected slat.

20. The horizontal fence system according to claim 19, wherein said stake and said post cover are constructed using the extrusion process.

21. The vertical fence system according to claim 19, wherein the material of construction for said stake, said post cover, said post cap, said base plate, and said base cover comprises of aluminum, aluminum alloy, metal, vinyl, plastic, or any combination thereof.

22. The vertical fence system according to claim 19, wherein said cover fasteners comprise of roll-black screws, thread rolling screws, screws, bolts, or any combination thereof.

23. The vertical fence system according to claim 19, wherein said plate fasteners comprise of fixing post screws, binding post screws, bolts, screws, or any combination thereof.
